(19) United States
(12) Patent Application Publication
(10) Pub. No.: US 2020/0061648 A1
(43) Pub. Date: Feb. 27, 2020

(54) SPRAYER ATTACHMENT FOR A GARDEN HOSE

(71) Applicant: David Meyer, SR., St. Bernard, LA (US)

(72) Inventor: David Meyer, SR., St. Bernard, LA (US)

(21) Appl. No.: 16/107,648

(22) Filed: Aug. 21, 2018

(51) Int. Cl. B05B 9/08; H01H 3/02

(52) U.S. Cl. CPC B05B 9/0811; B05B 11/0044; H01H 3/0206

(57) ABSTRACT

This present invention provides a gas cartridge sprayer attachment for a garden hose that is to be used in conjunction with a standard garden hose connector and increase pressure in the water flow, and thereby vary the spray distance in a manner suitable for gardening needs. The sprayer attachment has a pistol-shaped body, with a barrel portion provided with an on/off switch in its forward part, a trigger switch, which opens and closes fluid flow from the garden hose into the sprayer attachment, and a gas cartridge delivering pressuring gas into the water flow passing through the sprayer attachment body. The sprayer attachment is provided with an independent power source. A gas release switch is coupled to the power source and the gas cartridge for releasing the gas from the gas cartridge.

### BACKGROUND OF THE INVENTION

This invention relates to garden hose attachments, and more particularly, to a device delivering pressured gas into a water flow to increase the distance of the water stream when watering plants or performing other watering tasks.

This present invention provides a pressurized-gas sprayer attachment for a garden hose to increase and vary the spray type and distance in a manner suitable for gardening needs. The gas cartridge sprayer attachment for a garden hose utilizes compressed air or gas from a cartridge to build pressure that ejects water a greater distance from the hose. The benefit of a gas cartridge system is that it allows for finer, lighter, and more even streams of water to be ejected in a manner suitable for everyday garden work. To further increase efficiency and ease of use, this pumpless system prevents backflow into the hose thus further reducing the amount of pressure necessary to achieve desired distances while lengthening the time spent between refilling the cartridge.

A homeowner interested in gardening may desire to have a high degree of control and the options on a garden hose attachment for an effective, fine mist spray to use for watering of flowers or other delicate plants or a far more powerful stream to water more distant plants normally located out of reach of the garden hose. Delicate flowers, not suitable for a powerful stream, may be situated out of reach of typical fine mist sprays and may therefore be subjected to a harsher, harmful watering or cause the gardener to walk further into the garden and thus increase the time it takes to water the garden. Because gardening may be enjoyed by people of varying physical fitness and agility, a garden hose attachment seeking to solve these problems should be lightweight and relatively affordable and safe.

Traditional pump garden hose attachments work by pumping water coming out of the hose into a small opening thus increasing the pressure at the openings. Previous embodiments therefore are either pump or water-pressure based and do not provide a great amount of control or usability for fine mist sprays and lack the distance control a compressed gas attachment can provide.

For example, U.S. Pat. No. 6,811,099 for a “Battery Pack for Battery Operated Sprayer,” issued on Nov. 2, 2004 to assignee Saint-Gobain Calmar Inc., provides for a battery-operated sprayer that has an elongated handle for the operator to grip, allowing for the use of the sprayer and support for the container attached to the sprayer. The sprayer additionally features a removable battery pack, which forms a removable portion of the handle and solely supports a plurality of batteries that may be recharged or replaced by the operator. The invention therefore allows for a battery-operated trigger sprayer mountable on a container of spray product, with a removable battery pack to power the sprayer.

U.S. Pat. No. 6,554,211 for a “Container Vent Control for Battery Operated Sprayer,” issued on Apr. 29, 2003 to assignee Saint-Gobain Calmar Inc., provides for a container vent control for a manually-operated sprayer with a short flexible tubing section mounted within a cylindrical housing of the sprayer, with a vent port. A vent probe on the trigger lever is aligned with the vent port and collapses or flexes the tubing section upon manual pressure applied to the trigger level. The collapsed or flexed tubing section is unseated from the vent port upon the manual pressure and opens a vent into the interior of the container. The container vent control provided for the manually-operated sprayer is suitable for both a trigger-actuated pump sprayer with a reciprocal pump piston within a cylinder, the piston being actuated by manual operation of a trigger lever, and is also suitable for a battery-operated sprayer with an electric motor for operating the pump, a battery for operating the motor, and a manually-operated switch for selectively connecting and disconnecting the motor and the battery.

U.S. Pat. No. 6,502,766 for “Liquid Sprayers,” issued on Jan. 7, 2003 to assignee The Procter & Gamble Company, provides for a bottle with an opening and a sprayer housing attached to the bottle. The sprayer housing includes an electric motor; a voltage source for powering the electric motor; a pump driven by the motor; a switch for completing an electrical circuit; and a nozzle mechanism attached to the sprayer housing for spraying a liquid. The liquid sprayer also comprises a venting mechanism, which in turn features a vent housing having an inner surface and an outer surface, as well as a translating piston disposed in the vent housing. The electrical sprayer aims to provide a higher efficiency and limit the risk of malfunction due to contact between the sprayed liquid and electrical components featured in the sprayer.

U.S. Pat. No. 5,150,841 for a “Liquid Spray Dispenser,” issued on Sep. 29, 1992 to assignee DowBrands Inc., provides for a battery-operated hand-held dispenser that operates efficiently at lower power levels than prior art devices. The dispenser includes a spray, foam or stream, and dispensing capabilities coupled with pump mechanisms, vent mechanisms, and positive closures. Specifically, the invention features a vent apparatus for a container of liquid from which the liquid is dispensed, in turn featuring (1) a closure for the container, (2) a first passageway through the closure communicating with the outside environment, (3) a vent diaphragm having one side across the passageway and normally closing the passageway, (4) a second passageway adjacent the diaphragm, communicating with the interior of the container the second passageway being adjacent and normally closed by the one side of the vent diaphragm, and (5) a third passageway communicating with the other side of the diaphragm and the interior of the container, where the vent diagram is flexible, whereby when the pressure on the inside of the container is below that of the outside container, the vent diaphragm is dislodged, whereby the first passageway and the second passageway communicate with one another to permit gas flow from the exterior of the container to the interior of the container.

U.S. Pat. No. 3,993,250 for an “Apparatus for Spraying Liquid Materials,” issued on Nov. 23, 1976 to inventor Alan H. Shure, provides for a liquid-spraying apparatus that includes a pistol-gripped housing for a motor-driven pump and forming an inlet; a receptacle adapted to be secured to the housing adjacent the inlet; and a vacuum system member secured within the receptacle. The vacuum system member is adapted to be forced into sealing relationship with the inlet when the receptacle is secured to the housing, whereby the pump means will force liquid from the receptacle through a nozzle attached to the housing.

U.S. Pat. No. 5,397,034 for a “Finely Atomizing Device for Fluids,” issued on Mar. 14, 1995 to inventor Eckart Wunsch, provides for a device that includes a combination switch, with which an electric motor for a pump for spraying efficiency is activated, and simultaneously the pressure compensation in the container of the fluid is effected. Moreover, above the electric motor with the pump, a space is created for storing batteries. The device further features a section line, constructed of an elastic material and extending into the container is helically formed, whereby a discharge of the fluid is also possible in an inclined or upside-down position of the container.

U.S. Pat. No. 4,925,105 for a “Rechargeable Garden Sprayer,” issued on May 15, 1990 to inventor Hsien C. Lin, provides for a rechargeable garden sprayer that includes a container having an opening on an upper face, a lower suction tube, and an inlet formed at the side thereof. The inlet cooperates internally with the main body of the container such that liquid poured in through the inlet flows to the container. An engaging body has a base with about the same shape and size as the upper face of the container so as to be mounted on the container. The engaging body includes a number of upstanding hollow tubes along its periphery and a fixing panel to define a retaining recess. A top cover having substantially an inverted U-shaped body has two side panels with a number of downwardly extending poles at an inner side thereof for inserting into the hollow tubes and thus engaging with the engaging body. The top cover has a handle on its uppermost part. The garden sprayer further comprises a power unit including a closed-type battery, a socket, a pump, and a switch, and a nozzle tube that is telescopic and includes an engaging ring, a gripping tube, a soft hose, a middle tube, an upper tube, and a nozzle hand.

Lastly, U.S. Pat. No. 7,207,500 for a “Battery-Powered Pump for Liquid Sprayer,” issued on Apr. 24, 2007 to assignee H.D. Hudson Manufacturing Co., provides for a pump apparatus for a liquid sprayer with a housing adapted to be releasably connected to a vessel containing liquid to be sprayed. The housing includes an upper portion and a lower portion releasably connected to the upper portion. The upper portion includes at least a pump and an electric motor for driving the pump, and the lower portion includes at least a power supply for providing power to the motor. In certain embodiments, the vessel may include an internally threaded opening for engaging corresponding threads formed on at least part of the housing to releasably connect the housing to the vessel.

While the above discussed approaches may be beneficial in certain circumstances, there exists a need for an easy-to-operate and effective gas cartridge sprayer attachment for a garden hose that allows a user to access a greater amount of fine mist controls and to also deliver a spray at longer distances than traditional pump or pressure-based systems, while maintaining the integrity of gardening as an activity for those of all physical conditions. Although conventional pumps are suitable for moving a high volume of liquids at lower pressures, a gas cartridge sprayer attachment for a garden hose can provide selective and higher pressures at the openings than a pump will generate, thus allowing greater control and range even with fine mist streams.

### SUMMARY OF THE INVENTION

This present invention provides a compressed gas cartridge sprayer attachment for a garden hose that modifies fluid spray from the hose.

It is, therefore, an objective of the present invention to be attachable to a garden hose by threadably engaging the attachment with a garden hose ring.

It is further an objective of the present invention to generate a wide range of spray lengths by adjusting high and low spray pressures.

It is further an objective of the present invention to provide minute control over the spray length by adjusting air pressure.

It is further an objective of the present invention to break traditional length limits on mist types sprays by using high cartridge pressures to push fluid through narrow openings to generate fine streams.

It is further an objective of the present invention to maximize the potential of the cartridge pressures by including a backflow prevention seal to ensure fluid direction does not re-enter the hose.

It is further an objective of the present invention to provide a safe battery-operated gas cartridge attachment to a garden hose that can be used by people of different physical abilities.

It is further an objective of the present invention to provide a garden hose attachment that has a pressure release system to vent pressure build-ups and a secondary on/off switch, which is pressure dependent.

The present invention achieves these objectives by providing a gas cartridge sprayer attachment for a garden hose that is to be used in conjunction with a standard garden hose connector and increase pressure in the water flow, and thereby vary the spray distance in a manner suitable for gardening needs. The sprayer attachment has a pistol-shaped body, with a barrel portion provided with an on/off switch in its forward part, a trigger switch, which opens and closes fluid flow from the garden hose into the sprayer attachment, and a gas cartridge delivering pressuring gas into the water flow passing through the sprayer attachment body. The sprayer attachment is provided with an independent power source. A gas release switch is coupled to the power source and the gas cartridge for releasing the gas from the gas cartridge. Due to a backflow prevention seal, the present invention delivers this stream using lower gas pressures than otherwise necessary.

The present invention may also include a pump to further increase pressure but may operate without said pump. The present invention provides an easy to operate garden hose attachment that allows for greater control and range with spray types. This allows a gardener to decrease the time spent watering plants while more effectively delivering water to the plants and without damaging sensitive plant types.

### BRIEF DESCRIPTION OF THE DRAWINGS

Reference will now be made to the drawings, wherein like parts are designated by like numerals, and wherein:

FIG. 1 is a perspective view of the gas cartridge sprayer attachment of the present invention;

FIG. 2 is a partially cut-away view of the gas cartridge sprayer attachment of the present invention;

FIG. 3 is a partially cut-away view of an alternative embodiment of the gas cartridge sprayer attachment of the present invention without a water flow valve;

FIG. 4 is a partially cut-away view of the gas cartridge sprayer attachment of the present invention, wherein the gas cartridge is secured on the top of a handle, and illustrating water flow in the alternative embodiment and illustrating an alternative trigger switch; and

FIG. 5 is a perspective view illustrating the gas cartridge sprayer attachment of the present invention in use by a gardener.

### DETAILED DESCRIPTION OF THE INVENTION

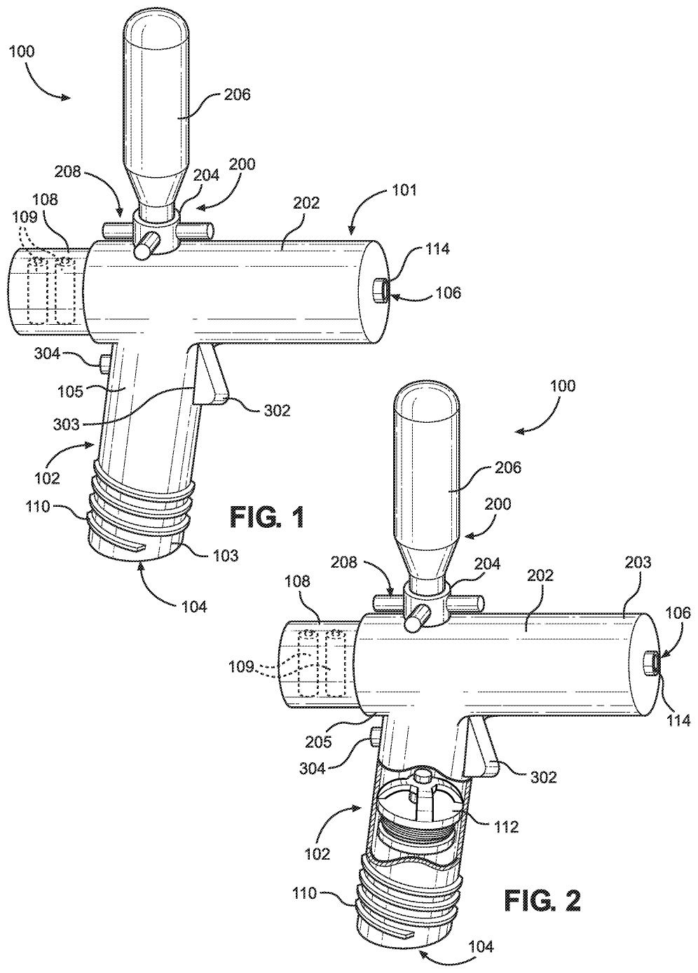

Referring generally to FIGS. 1-5, the drawings show the compressed gas sprayer attachment for garden hose 100 of the present invention. The gas cartridge attachment for garden hose 100 comprises a pistol-shaped hollow body 101 having a handle portion 102 and a unitary formed, barrel portion 202. The handle portion 102 has a flow entry point 104 in a bottom part 103, and the barrel portion 202 is provided with a flow exit point or outlet opening 106 in a forward end 203. If desired, the handle portion 102 can be made with anti-slip outer surface to facilitate handling of the attachment device 100 by a user.

The attachment device 100 is provided with an independent power source. The body 101 has a battery compartment 108 for housing at least one battery 109. The battery compartment 108 is secured in substantially co-axial alignment with the barrel portion 202, at a rear part 205 of the barrel portion. The battery compartment 108 can be unitary formed with the barrel portion 202 or can be detachably secured to the barrel portion.

A gas delivery assembly 200 is coupled the barrel portion 202 and is mounted in general vertical alignment with the handle portion 102. The gas delivery assembly 200 comprises a detachably mounted gas cartridge 206, a pressure gate 204, and an incorporated safety valve 208. The pressure gate 204 with the safety valve 208 are sandwiched between the gas cartridge 206 and the barrel portion 202. The gas from the gas cartridge 206 is delivered into the hollow barrel portion. The safety valve 208 prevents accidental discharge of gas when the gas cartridge 206 is removed from the barrel 202. The pressure gate 204 allows changing of gas cartridges 206 once the gas cartridge becomes empty or no longer needed. The safety valve 208 closes the outlet of the gas cartridge when the gas cartridge is removed from the attachment device 100.

In some embodiments, a pressure gauge is operationally connected to the pressure valve 208. The gas cartridge 206 must be of a material strong enough to withstand significant pressures, and it may be operationally attached under or over the pressure receiving chamber formed inside the barrel portion. In alternate embodiments of the invention, there may be two or more gas cartridges operationally connected to the pressure receiving chamber.

The barrel portion 202 is provided with a flow guide or on/off switch 114, which is mounted in a surrounding relationship over the outlet opening 106. The switch 114 rotates in relation to the barrel, closing and opening the outlet 106. If desired, a flow regulating plate can be mounted in the opening 106 to provide the user with greater flexibility in adjusting the flow pattern exiting the attachment 100. In this manner, the attachment can generate fine mist or heavier stream when the user manipulates the flow guide 114.

The handle portion 102 is provided with external threads 110 in the bottom part 103 to allow the attachment device 100 to be threadably engaged with a standard garden hose connector. A slot 303 is formed in the upper part 105 of the handle portion 102, and a sprayer trigger 302 extends outwardly therefrom. The sprayer trigger switch 302 is adapted to be manually depressed to open a flow valve mounted inside the device 100. A water flow valve 112 is fitted inside the handle portion below the sprayer trigger 302. The water flow valve 112 is operationally connected to the sprayer trigger 302 and acts to open or close the water flow from the garden hose into the attachment device 100 and to prevent backflow from the sprayer attachment device 100 to the garden hose 120.

A gas release switch 304 is mounted in the upper part 105 of the handle portion 102 opposite the sprayer trigger 302. The gas release switch 304 is operationally connected to the gas delivery assembly 200 and to the batteries 109. When depressed, the gas release switch 304 activates the release of gas from the gas cartridge 206 into the flow of water passing through the barrel portion 202, significantly increasing the pressure of the water flow exiting the attachment device 100.

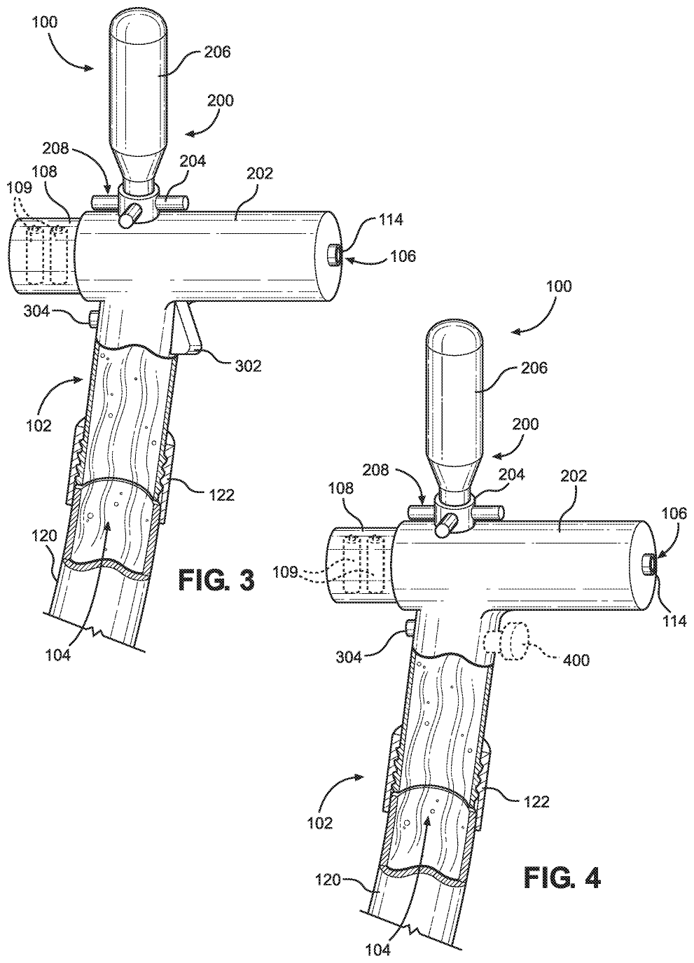

FIG. 3 schematically illustrates the flow of water through a garden hose 120 into the attachment device 100. In this embodiment, the water flow valve 112 is omitted, and the water flow regulation is provided by the trigger switch 302, the on-off flow guide or on/off switch 114, and the gas release switch 304. A hose connector 122 secured on the end of the garden hose 120 is threadably attached to the external threads 110 of the handle portion 102. As a result, the garden hose 120 and the attachment device 100 are fluidly connected when water is supplied to the garden hose 120 from a municipal water source or reservoir.

In an alternate embodiment of the invention, there may be a water pump powered by an analog or battery power source placed in-between the garden hose thread attachment 110 and backflow seal 112. This would be controlled by a switch 400 shown in FIG. 4. Thus, water will be pumped into the pressure receiving chamber inside the barrel 202 at a higher velocity. However, this spray may have lower velocity than spray with the gas cartridge 206.

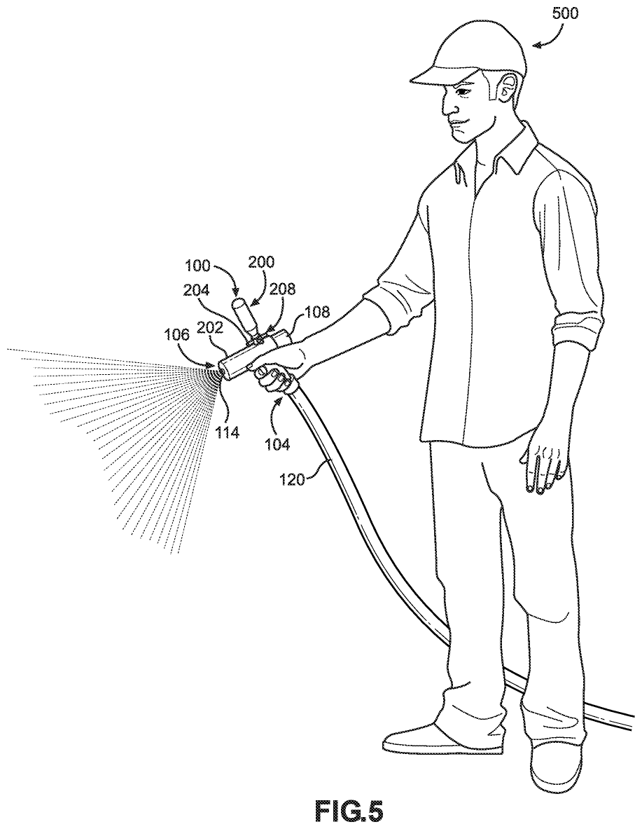

FIG. 5 illustrates the use of the attachment device. Here a gardener 500 holds the attachment device using the handle portion 102 and pressing the sprayer trigger 302. Before water can exit the attachment device 100, the gardener rotates the on-off switch 114 into the “on” position and presses on the gas release switch 304 using the palm of his hand. The gas from the cartridge 206 is gradually released, mixing with the flow of water supplied from the garden hose 120.

When the gas cartridge 206 is empty, the user 500 shuts off the water flow, and then the pressure in the hollow pressure receiving chamber 202 should be released automatically through the exhaust opening 106. If gas cartridge is not completely empty, then the pressure in the gas cartridge 206 should be drained before removal of the gas cartridge 206. In that case, the user shuts off the water flow, removes the attachment device from the garden hose, vents remaining pressure in the gas cartridge, and then removes the gas cartridge from the barrel portion.

Many changes and modifications can be made in the design of the present invention without departing from the spirit thereof. I, therefore, pray that my rights to the present invention be limited only by the scope of the appended claims.

I claim:

1. A garden hose attachment apparatus for use with a garden hose equipped with a standard hose connector, the apparatus comprising:
(i) a hollow pistol-shaped body having a handle portion and a barrel portion unitary connected to the handle portion, the handle portion being configured to be fluidly coupled to a water source through the standard hose connector; and
(ii) a gas delivery assembly detachably coupled to the barrel portion, the gas delivery assembly comprising a source of pressurized gas and adapted for delivery of pressurized gas into a water stream traveling through the barrel portion.

2. The apparatus of claim 1, said barrel portion comprising a manually-operated on/off switch configured to prevent release of water when in an off position.

3. The apparatus of claim 1, wherein the gas delivery assembly comprises a pressure gate secured to the barrel portion, a safety valve incorporated into the pressure gate, and a gas cartridge detachably mounted on the detachably pressure gate.

4. The apparatus of claim 3, wherein the pressure gate with the incorporated safety valve are sandwiched between the gas cartridge and the barrel portion.

5. The apparatus of claim 1, further comprising a gas release switch mounted on the handle portion and operationally connected to the gas delivery assembly.

6. The apparatus of claim 5, further comprising an independent power source for activating delivery of gas from the gas cartridge.

7. The apparatus of claim 6, wherein the power source is housed in a compartment secured to the barrel portion.

8. The apparatus of claim 6, wherein the power source is at least one battery.

9. The apparatus of claim 6, wherein the gas release switch is operationally connected to the power source.

10. The apparatus of claim 1, further comprising a trigger switch secured to the handle portion, the trigger switch being adapted to be manually depressed to allow flow of water through the barrel portion.

11. The apparatus of claim 10, further comprising a water flow valve mounted in the handle portion and operationally connected to the trigger switch.

12. The apparatus of claim 1, wherein the handle portion is provided with external threads configured to connect the handle portion to the garden hose through the standard hose connector.

13. A method of increasing pressure of water flow through a garden hose equipped with a standard hose connector, the method comprising the steps of:
(i) providing a hose attachment device comprising a hollow pistol-shaped body having a handle portion and a barrel portion unitary connected to the handle portion, the handle portion being configured to be fluidly coupled to a water source through the standard hose connector;
(ii) providing a gas delivery assembly detachably coupled to the barrel portion, the gas delivery assembly comprising a source of pressurized gas and adapted for delivery of pressurized gas into a water stream travelling through the barrel portion;
(iii) detachably coupling the hose attachment device through the standard hose connector;
(iv) establishing a fluid flow from the garden hose to the attachment device;
(v) admitting gas from the gas delivery assembly into the fluid flow; and
(vi) causing the fluid flow to exit the attachment device at a desired pressure.

14. The method of claim 13, further comprising a step of providing the barrel portion with a manually-operated on/off switch configured to prevent release of water when in an off position.

15. The method of claim 13, wherein the gas delivery assembly comprises a pressure gate secured to the barrel portion, a safety valve incorporated into the pressure gate, and a gas cartridge detachably mounted on the detachably pressure gate, and wherein the pressure gate with the incorporated safety valve are sandwiched between the gas cartridge and the barrel portion.

16. The method of claim 13, further comprising a step of providing the handle portion with a gas release switch operationally connected to the gas delivery assembly, providing an independent power source for activating delivery of gas from the gas cartridge, the gas release switch being operationally connected to the power source.

17. The method of claim 16, further comprising a step of manually operating the gas release switch, thereby causing gas from the gas cartridge to be released into the fluid flow.

18. The method of claim 16, further comprising a step of providing the barrel portion with a compartment for housing the independent power source.

19. The method of claim 13, further comprising the step of providing the handle portion with a trigger switch and manually depressing the trigger switch to allow flow of water through the barrel portion.

20. The method of claim 19, further comprising a step of providing the handle portion with a water flow valve operationally connected to the trigger switch, and causing the water flow valve to be open and closed by operation of the trigger switch.
